(19) United States
(12) Patent Application Publication
(10) Pub. No.: US 2014/0156865 A1
(43) Pub. Date: Jun. 5, 2014

(54) Generic Substitution Parameters in DASH

(71) Applicant: Futurewei Technologies, Inc., Plano, TX (US)

(72) Inventor: Alexander Giladi, Princeton, NJ (US)

(73) Assignee: Futurewei Technologies, Inc., Plano, TX (US)

(21) Appl. No.: 14/091,409

(22) Filed: Nov. 27, 2013

Related U.S. Application Data
(60) Provisional application No. 61/731,675, filed on Nov. 30, 2012.
(60) Provisional application No. 61/752,116, filed on Jan. 14, 2013.

(51) Int. Cl. H04L 29/06

(52) U.S. Cl. CPC H04L 65/608
USPC 709/231

(57) ABSTRACT

A method for preparing media content in a Dynamic Adaptive Streaming over Hypertext Transfer Protocol (DASH), comprising generating a parameter that comprises an identifier associated with a string value and encoding the parameter within a media presentation description (MPD), wherein the parameter is configured to be set with a parameter value independently of when the MPD is generated, and wherein the MPD provides presentation information for a media content. In another embodiment, a method for adaptive streaming of a media content in a DASH, comprising receiving an MPD that provides presentation information for the media content, determining one or more generic parameters within the MPD, and substituting one or more values for the generic parameters obtained from the MPD, wherein the generic parameters reference at least one of the following: attributes within the MPD, remote elements not available during MPD generation, and streaming client applications.

### CROSS-REFERENCE TO RELATED APPLICATIONS

The present application claims priority to U.S. Provisional Patent Application No. 61/731,675 filed Nov. 30, 2012 by Alexander Giladi and entitled “Generic Substitution Parameters in DASH,” and U.S. Provisional Patent Application No. 61/752,116 filed Jan. 14, 2013 by Alexander Giladi and entitled “Use of Generic Parameters in DASH Applications,” all of which are incorporated herein by reference as if reproduced in their entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Web-media streaming has become common place as smart phones, tablets, notebooks, Internet connected televisions, and other devices configured to access the Internet increase in popularity. Adaptive streaming technology, such as Dynamic Adaptive Streaming over Hypertext Transfer Protocol (DASH), Hypertext Transfer Protocol (HTTP) Live Streaming (HLS), and Internet Information Services (IIS) Smooth Streaming, is an emerging technology that aims to improve an end user's media streaming experience. In adaptive streaming, a user device may select and receive appropriate media segments dynamically based on a variety of factors, such as network conditions, device capability, and user choice. For instance, when employing DASH, a media content provider may, upon request, transmit a media presentation description (MPD) to the client. The MPD may be a document file, such as an extensible markup language (XML) document that describes the media content as media segments and includes information to utilize the media segments in order to present the media content to a user. For example, the MPD may describe segment timing, segment multiplexing (e.g. interrelation between audio segment and video segment timings), and/or Uniform Resource Locator (URL) information. Moreover, the streamed media content may comprise several media components (e.g. audio, video, and text), each having different characteristics specified in the MPD.

Web-streaming services may be categorized as on-demand services and live services. In on-demand services (e.g. streaming a movie file or recorded television show), all of the media segments for the streamed media content may be available on the server to stream once any of the media segments is ready to stream. As such, the MPD may be a static file that does not need to be updated. Conversely, with live services (e.g. a live broadcast of a football game or news program), segments of the streamed media content are available with time as the content is being produced. As a result, during live services, the MPD may need to be generated in real-time for each end user. Unfortunately, generating the MPD in real-time rather than distributing a cached MPD file may cause scalability issues and performance degradation when supporting a vast number of end users participating in a live service.

### SUMMARY

In one embodiment, the disclosure includes a method for preparing media content in DASH, the method comprising: generating a parameter that comprises an identifier associated with a string value and encoding the parameter within an MPD, wherein the parameter is configured to be set with a parameter value independently of when the MPD is generated, and wherein the MPD provides presentation information for a media content.

In another embodiment, the disclosure includes an apparatus for preparing media content for adaptive streaming, comprising a memory, a processor coupled to the memory, wherein the memory includes instructions that when executed by the processor cause the apparatus to perform the following: generate a parameter that comprises one or more attributes and encode the parameter within a MPD, wherein the one or more attributes specifies the parameter's name, a value for the parameter, and a format for the value, wherein the parameter supports setting the value after generating the MPD, and wherein the MPD describes media content information in DASH.

In yet another embodiment, the disclosure includes a method for adaptive streaming of a media content in DASH, the method comprising receiving an MPD that provides presentation information for the media content, determining one or more generic parameters within the MPD and substituting one or more values for the generic parameters obtained from the MPD, wherein the generic parameters reference at least one of the following: one or more attributes within the MPD, one or more remote elements not available during MPD generation, and one or more streaming client applications.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a media streaming scheme where embodiments of the present disclosure may operate.

FIG. 2 is a schematic diagram of an embodiment of a network element, which may be any device that transports and/or processes media content through a network.

FIG. 3 is a schematic diagram of an embodiment of a hierarchical data model of an MPD.

FIG. 4 is a flowchart of an embodiment of a method that prepares an MPD that comprises one or more generic substitution parameters.

FIG. 5 is a flowchart of an embodiment of a method that processes an MPD that comprises one or more generic substitution parameters.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents. While certain aspects of conventional technologies have been discussed to facilitate the present disclosure, applicants in no way disclaim these technical aspects, and it is contemplated that the present disclosure may encompass one or more of the conventional technical aspects discussed herein.

Disclosed herein are at least one method, apparatus, and system that generate and/or perform operations using one or more generic substitution parameters within an MPD. The generic substitution parameters may be declared within an MPD. Values for the generic substitution parameters may be computed and/or assigned independently of the MPD generation. For example, the values for the generic substitution parameters may be set when a client performs an operation corresponding to the generic substitution parameter and/or when the media content becomes available. The generation of generic substitution parameters within an MPD may be applied to a variety of use cases that include, but are not limited to, reducing the MPD file size, creating a cached MPD for distribution amongst one or more streaming clients, URL signing, constructing templates for MPD updates, and clock synchronization between a client and a server.

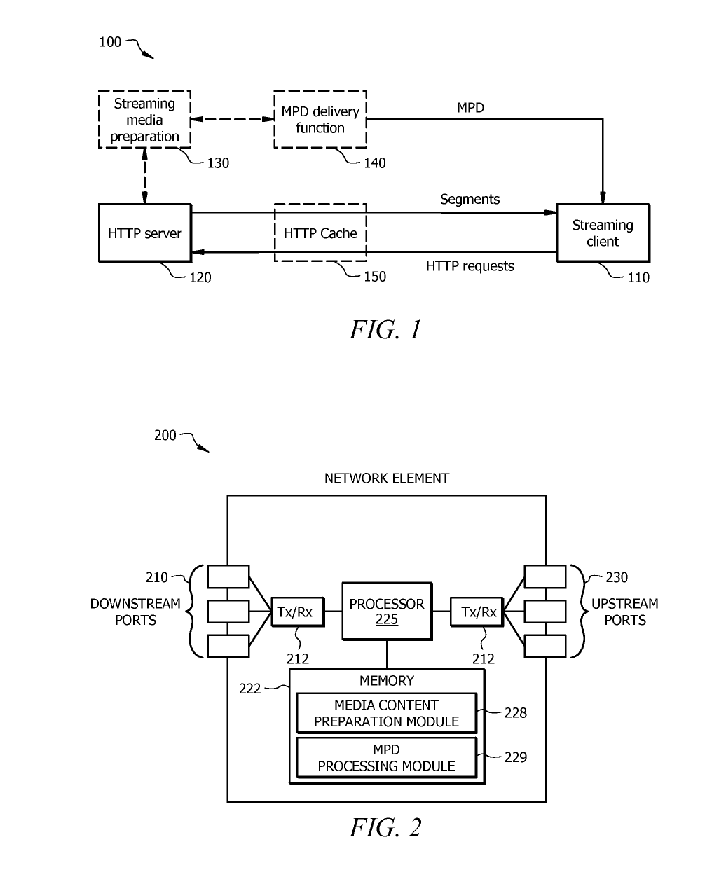

FIG. 1 is a schematic diagram of an embodiment of a media streaming system 100 where embodiments of the present disclosure may operate. Media streaming system 100 may be implemented to deliver media content from an HTTP server 120 to a streaming client 110. Media streaming system 100 may be configured to implement DASH as described in International Organization for Standardization/International Electrotechnical Commission (ISO/IEC) document 23009-1:2012(E) entitled “Information technology-Dynamic adaptive streaming over HTTP (DASH)—Part 1: Media presentation description and segment formats” (ISO/IEC 23009-1), which is incorporated herein by reference. Although the disclosure and media streaming system 100 are directed toward DASH, the disclosure and media streaming system 100 are not limited to DASH and may instead apply equally to other adaptive streaming schemes, such as HLS or IIS Smooth Streaming. For example, the MPD may also be referenced as a “playlist” and/or “manifest” in other adaptive streaming protocols. The use and discussion of DASH is served solely to facilitate ease of description and explanation.

The streaming client 110 within the media streaming system 100 may be, but is not limited to, a stand-alone device (e.g. personal computer and/or mobile device), a program or application implemented in an operating system of a user device, a web client accessed in a web platform, and/or any combination thereof. The media content stored in the HTTP server 120 may be generated or prepared by a streaming media preparation unit 130. The media preparation unit 130 may be located within the HTTP server 120, an end user, a network element, and/or elsewhere (e.g. in a content provider site). The HTTP server 120 may be part of a content provider network or may be a network element in a content distribution network (CDN).

The media content may be generated at least in part by one or more content providers and then transmitted to a CDN network element. The media content in the HTTP server 120 may comprise an MPD and a plurality of media segments. Note that, if desired, the MPD and the media segments may be stored and/or cached in different servers and retrieved by the streaming client 110 from different servers. In addition, an HTTP server 120 described herein merely serves as an example of a server. Embodiments disclosed herein may also be implemented in an origin server, web server, or any other suitable type of server in addition to the HTTP server 120. Additionally, more than one HTTP server 120 and/or other suitable types of servers may store media content and may be connected to a CDN.

In media streaming system 100, the streaming client 110 may send a request to the HTTP server 120 for media content. In response, the HTTP server 120 may first use an MPD delivery function 140 to deliver an MPD to the streaming client 110. The MPD may be delivered using HTTP, HTTP secure (HTTPS), email, Universal Serial Bus (USB) drive, broadcast, or any other transport well known in the art. By parsing the MPD, the streaming client 110 may learn information regarding the media content, such as the timing of the program, the availability of media content, the media types, resolutions, minimum and maximum bandwidths, the existence of various encoded alternatives of multimedia components, the accessibility features and the required digital right management (DRM), the location of each media component on the network, and other characteristics of the media content and delivery environment. Other embodiments of media streaming system 100 may deliver media content information using a playlist, manifest, and/or other types of data to describe information regarding the media content.

Using the media content and delivery environment information, the streaming client 110 may select the appropriate encoded representation or combination of representations and start streaming the media content by fetching media segments using HTTP Get requests. The HTTP server 120 may use a segment delivery function to deliver the media segments to the streaming client 110. Note that the streaming client 110 may download media segments from a plurality of HTTP servers 120 (e.g. to maximize usage of network bandwidth). The media segments may also be stored into one or more HTTP servers 120 connected to a CDN. The streaming client 110 may render the downloaded media appropriately so as to provide streaming service to a user of the streaming client 110. Although the streaming client 110 may obtain the media segments based from locations specified by the URL addresses within the MPD, the media segments may alternately be stored in an HTTP cache 150 (e.g. in the HTTP server 120 or a CDN network element) to improve the efficiency of streaming client's 110 receipt.

If buffering is needed, after appropriate buffering to allow for network throughput variations, the streaming client 110 may continue to download subsequent segments while monitoring bandwidth fluctuations of the network. Depending on measurements the streaming client 110 conducts or notifications it receives, the streaming client 110 may adaptively adjust streaming to the available bandwidth by downloading segments of different representations (e.g. with a lower or higher bitrate) to maintain an adequate buffer.

In regards to DASH, media streaming system 100 may specify the format of the MPD and the segment formats for DASH. A piece of the media content may be specified by an MPD that comprises a plurality of segment elements. An MPD may also comprise other elements and attributes programmed to describe information regarding the media content. The MPD may be an XML file or some other type of document that describes the media content, such as its various representations, URL addresses, media segments, and other characteristics. For example, the media content (e.g. live broadcast) may comprise several media components (e.g. audio, video, and text), each of which may have different characteristics that are specified in the MPD. Each media component may comprise a plurality of media segments containing the parts of actual media content, and information of the media segments may be stored collectively in a single file or individually in multiple files. Each media segment may contain a pre-defined byte size (e.g. 1,000 bytes) or an interval of playback time (e.g. 2 or 5 seconds) of the media content. A media segment may indicate the minimal individually addressable unit of data that can be downloaded using URL addresses advertised via the MPD.

During MPD generation, the HTTP server 120 and/or the streaming media preparation unit 130 may declare generic substitution parameters within the MPD. A generic substitution parameter may be a symbolic name and/or identifier associated with a value. The generic substitution parameters may be declared within the MPD for a variety of purposes, such as using generic substitution parameters within a template (e.g. URL template) for the purpose of URL construction and/or reducing the MPD file size. The generic substitution parameter may have values that may be part of a URL string. Additionally, a streaming client 110 may receive a generic substitution parameter within an MPD and perform an operation that corresponds to the generic substitution parameter. Table 1 provides the semantics of a generic substitution parameter:

TABLE 1

| Element or | | |
|---|---|---|
| Attribute Name | Use | Description |
| Parameter | | This element contains a generalized description |
| | | of a generic substitution parameter. |
| @identifier | M | Specifies the name for the generic substitution |
| | | parameter |
| @value | M | Specifies a value for the generic substitution |
| | | parameter |
| @format | M | Specifies the format for the generic substitution |
| | | parameter is for a printf-style format string. If |
| | | not present then default to string formatting. |

Legend:
For attributes:
M = Mandatory,
O = Optional,
OD = Optional with Default Value,
CM = Conditionally Mandatory.

As shown in Table 1, a generic substitution parameter may be represented as a parameter element. The parameter element may comprise the attributes “@identifier,” “@value,” and “@format.” The “@identifier” attribute may specify the generic substitution parameter's name, and the “@value” attribute may provide a generic substitution parameter value. The “@format” may specify the format for the “@value” attribute and may have a default of string formatting (e.g. URL string). In other embodiments, the attributes “@identifier,” “@value,” and “@format” for the generic substitution parameter may be combined into one or more attributes. For example, the “@identifier” and “@value” attribute may be combined into a single attribute (e.g. “name1=value1&name2=value2”).

Tables 2 and 3 shown below provide XML syntax for encoding and using a generic substitution parameter. Specifically, Table 2 provides the XML syntax that may be used to represent the generic substitution parameter element within an MPD XML file:

```
TABLE 2
<xs:complexType name=“Parameter”>
  <xs:attribute name=“identifier” type=“xs:token” use=“required”/>
  <xs:attribute name=“value” type=“xs:token” use=“required”/>
  <xs:attribute name=“format” type=“xs:token” default=“s”/>
</xs:complexType>
```

As shown in Table 2, the “@value” attribute is expressed using “xs:token.” In another embodiment, a relatively less restrictive way of expressing the “@value” may be to use the “xs:anyType” as opposed to “xs:token.” Table 3 provides an example of XML syntax that uses the generic substitution parameter:

TABLE 3
<Parameter identifier=“ContentID” value=“123456789ABCDEF”/>
<SegmentTemplate duration=“4” startNumber=“1”
media=“$RepresentationID$_$Number%05d$.ts?cid=$ContentID$” />

In Table 3, the generic substitution parameter may be identified as “ContentID” and may have a value of “123456789ABCDEF.” The value of “123456789ABCDEF” may be represented as a string. Moreover, the identifier “ContentID” may be referenced within the “@ media” attribute for the “SegmentTemplate” element. Recall that a value for the generic substitution parameter value may not be set during the generation of the MPD, and instead may be set after generating the MPD. For example, during URL construction, the identifier “ContentID” may be substituted with the value “123456789ABCDEF,” which may have been generated after an HTTP server generates the MPD. The identifier “ContentID” within the URL template is between the “$” character. Another example may be a generic substitution parameter with an identifier of “LifeThe UniverseAndEverything” that has a value “42.” When a DASH client sees a URL template “http://example.com/segment$LifeUniverseAndEverything$.mp4” (note that the parameter name “LifeThe UniverseAndEverything” is between the ‘$’ characters), the DASH client may request a URL “http://example.com/segment42.mp4” from the HTTP server.

At least some of the features/methods described in the disclosure may be implemented in a network element. For instance, the features/methods of the disclosure may be implemented using hardware, firmware, and/or software installed to run on hardware. The network element may be any device that transports data through a network, e.g. a switch, router, bridge, server, client, etc. FIG. 2 is a schematic diagram of an embodiment of a network element 200, which may be any device that transports and/or processes media content through a network. For instance, the network element 200 may be any apparatus used to prepare media content and/or receive media content. For example, network element 200 may be streaming client 110, HTTP server 120, or streaming media preparation unit 130 shown in FIG. 1. The network element 200 may also be configured to implement or support MPD generation and processing as described in methods 400 and 500.

The network element 200 may comprise one or more downstream ports 210 coupled to a transceiver (Tx/Rx) 212, which may be transmitters, receivers, or combinations thereof. The Tx/Rx 212 may transmit and/or receive frames from other nodes via the downstream ports 210. Similarly, the network element 200 may comprise another Tx/Rx 212 coupled to a plurality of upstream ports 230, wherein the Tx/Rx 212 may transmit and/or receive frames from other nodes via the upstream ports 230. The downstream ports 210 and/or upstream ports 230 may include electrical and/or optical transmitting and/or receiving components.

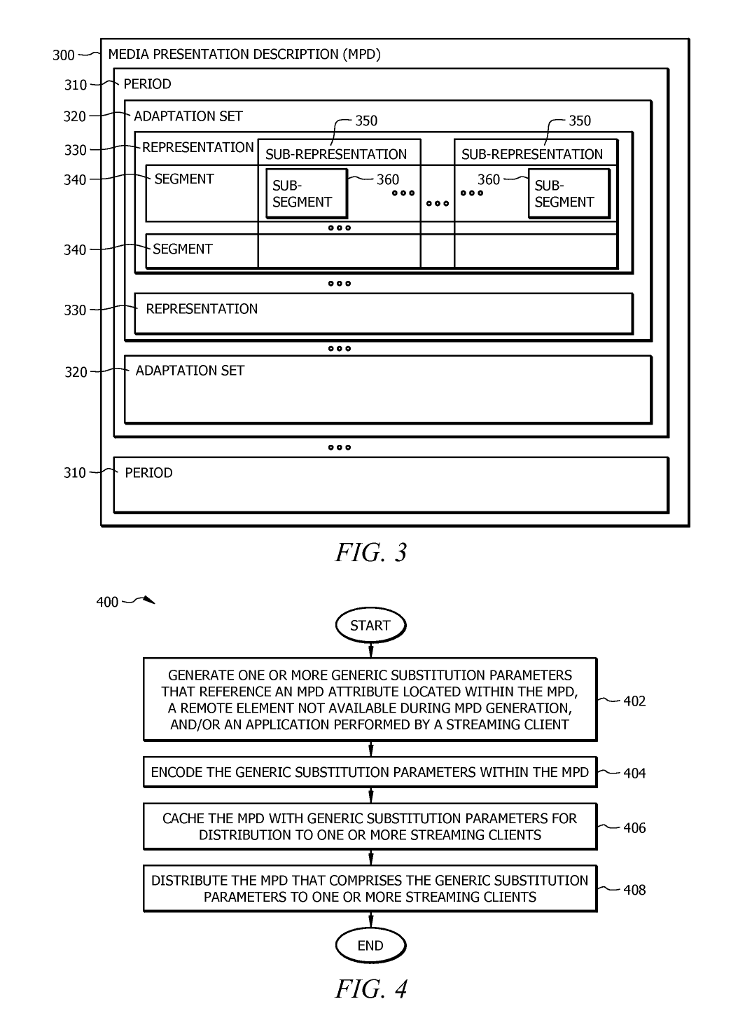

A processor 225 may be coupled to the Tx/Rx 212 and be configured to process the frames and/or determine which nodes to send the frames. The processor 225 may comprise one or more multi-core processors and/or memory modules 222, which may function as data stores, buffers, etc. The processor 225 may be implemented as a general processor or may be part of one or more application specific integrated circuits (ASICs) and/or digital signal processors (DSPs). Although illustrated as a single processor, the processor 225 is not so limited and may comprise multiple processors. The processor 225 may be configured to implement any of the schemes described herein, including methods 300 and 400 as described in FIGS. 3 and 4, respectively.

Memory module 222 may be coupled to the processor 225 and may be non-transitory mediums configured to store various types of data. Memory module 222 may comprise memory devices including secondary storage, read only memory (ROM), and random access memory (RAM). The secondary storage is typically comprised of one or more disk drives, solid-state drives (SSDs), and/or tape drives and is used for non-volatile storage of data and as an over-flow data storage device if the RAM is not large enough to hold all working data. The secondary storage may be used to store programs that are loaded into the RAM when such programs are selected for execution. The ROM is used to store instructions and perhaps data that are read during program execution. The ROM is a non-volatile memory device that typically has a small memory capacity relative to the larger memory capacity of the secondary storage. The RAM is used to store volatile data and perhaps to store instructions. Access to both the ROM and the RAM is typically faster than to the secondary storage.

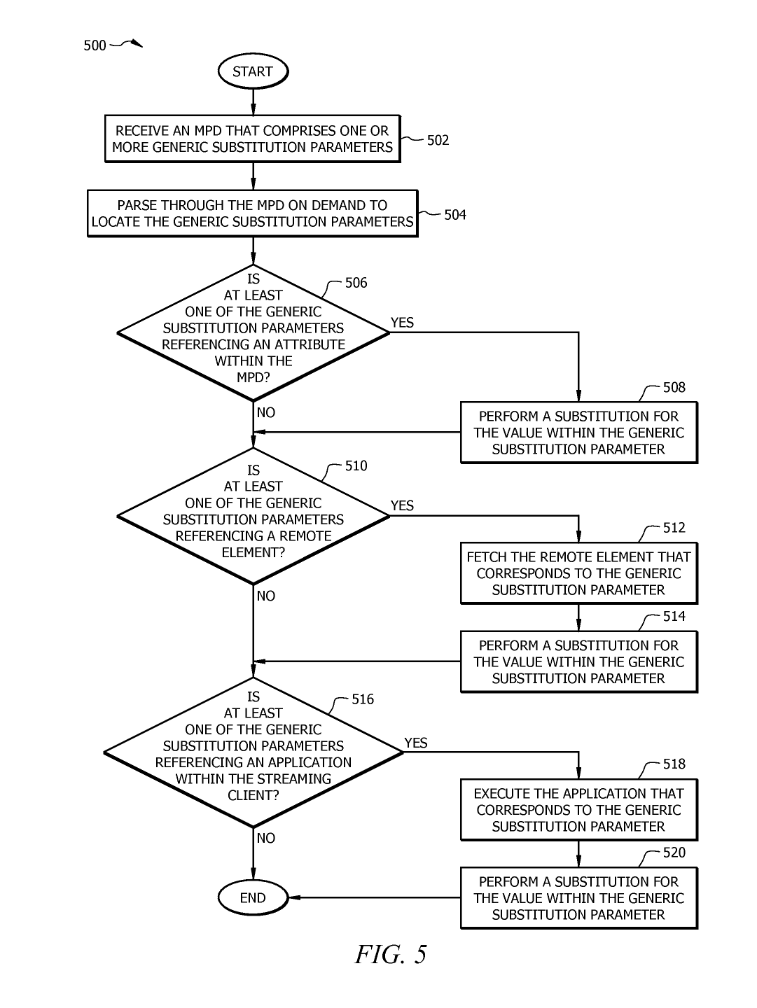

The memory module 222 may be used to house the instructions for carrying out the system and methods described herein, e.g. as a streaming client 110, as an HTTP server 120, as a streaming media preparation 130, etc. In one embodiment, the memory module 222 may comprise a media content preparation module 228 that may be implemented on the processor 225. Alternately, the media content preparation module 228 may be implemented directly on the processor 225. The media content preparation module 228 may be configured to generate the MPD used to provide media content information for a client. During MPD generation, the media content preparation module 228 may insert and/or declare generic substitution parameters within the MPD. The generic substitution parameters may be used for a variety of purposes, such as caching an MPD, URL signing, and/or referencing operations for a streaming client. Generating the MPD with generic variables and implementing the generic variables for a variety of use cases will be discussed in more detail in FIG. 4. In another embodiment, the memory module 222 may comprise an MPD processing module 229 that may parse and process the MPD with generic substitution parameters. For example, the MPD processing module 229 may assign values to the generic substitution parameters and/or perform operations based on the generic substitution parameters. Processing the MPD will be discussed in more detail in FIG. 5.

It is understood that by programming and/or loading executable instructions onto the network element 200, at least one of the processor 225, the cache, and the long-term storage are changed, transforming the network element 200 in part into a particular machine or apparatus, e.g. a multi-core forwarding architecture, having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design may be developed and tested in a software form and later transformed, by well-known design rules, to an equivalent hardware implementation in an ASIC that hardwires the instructions of the software. In the same manner as a machine controlled by a new ASIC is a particular machine or apparatus, likewise a computer that has been programmed and/or loaded with executable instructions may be viewed as a particular machine or apparatus.

FIG. 3 is a schematic diagram of an embodiment of a hierarchical data model of an MPD 300. The MPD 300 may comprise a Period element 310, an Adaptation Set element 320, a Representation element 330, a Segment element 340, a Sub-Representation element 350, and a Sub-Segment element 360. The Period element 310 may represent a media content period. Parameters within the media content period, such as available bitrates, languages, captions, and subtitles, may be changed within the period using generic substitution parameters. The Adaptation set element 320 may represent a set of interchangeable encoded versions of one or more media content components. For example, one Adaptation Set element 320 may pertain to a video media content type, while another Adaptation Set element 320 may pertain to an audio media content type. The Representation element 330 may describe a deliverable encoded version for one or several media content components. Using FIG. 1 as an example, the streaming client 110 may switch representations in order to adapt to network conditions and/or other factors. The streaming client 110 may download each media segment within a selected representation until the streaming client 110 ceases downloading or until the streaming client 110 selects another representation. As such, the adaptability of DASH may lie among a set of mutually interchangeable Representation elements 330. Certain embodiments of the Period element 310, Adaptation Set element 320, Representation element 330, Segment element 340, Sub-Representation element 350, and Sub-Segment element 360 are described in more detail in the ISO/IEC document 23009-1.

FIG. 4 is a flowchart of an embodiment of a method 400 that prepares an MPD that comprises one or more generic substitution parameters. Method 400 may be implemented by one or more HTTP servers, network elements, and/or any other type of device that prepares media content for streaming. Using FIG. 1 as an example, method 400 may be implemented in the streaming media preparation unit 130, which may be located in an HTTP server 120. The generation of generic substitution parameters within an MPD may be parameters used for assigning MPD attributes and/or referencing an operation performed by the streaming client. After generating the MPD, method 400 may distribute the MPD to one or more streaming clients.

Method 400 may start at block 402 and generate one or more generic substitution parameters that reference: an MPD attribute located within the MPD, a remote element not available during MPD generation, and/or an application performed by a streaming client. The semantics and uses for the generic substitution parameters will be discussed in more detail in Tables 4-11. Method 400 may then move to block 404 and encode the generic substitution parameters within the MPD. In one embodiment, the MPD may be encoded as an XML file. Afterwards, method 400 may move to block 406 and cache the MPD with generic substitution parameters for distribution to one or more streaming clients. Method 400 may continue to block 408 and distribute (e.g. transmit) the MPD that comprises the generic substitution parameters to one more streaming clients.

Recall that at block 402, method 400 may generate generic substitution parameters that reference an MPD attribute located within the MPD. Table 4 provides the semantics of a generic substitution parameter that references an MPD attribute located within the MPD at the time of MPD generation:

TABLE 4

| Element or | | |
|---|---|---|
| Attribute Name | Use | Description |
| Parameter | | This element contains a generalized description of |
| | | a generic substitution parameter. |
| @identifier | M | Specifies the name for the generic substitution |
| | | parameter |
| @value | M | Specifies a value for the generic substitution |
| | | parameter |
| @format | M | Specifies the format for the generic substitution |
| | | parameter is for a printf-style format string. If not |
| | | present then default to string formatting. |
| @location | O | Specifies an XML Path Language (XPath) |
| | | location path. |

Legend:
For attributes:
M = Mandatory,
O = Optional,
OD = Optional with Default Value,
CM = Conditionally Mandatory.

In Table 4, when a generic substitution parameter is used to reference an MPD attribute located within the MPD at the time of MPD generation, the parameter element may further comprise a “@location” attribute. The “@location” attribute may specify a location path within the MPD file. In one embodiment, the “@location” attribute may be a subset of the XPath functionality that may extract the position of an MPD element and/or use equality predicates of “@identifier” attributes of the referenced element. For example, method 400 may determine the position of an MPD element by referring to the position of the element within its parent element when extracting the position of the MPD element. Alternatively, when using equality predicates of “@identifier” attributes, method 400 may obtain the position of the MPD element by determining whether “@location” attribute has the same value as the “@identifier” attribute for the MPD element. Generic substitution parameters used to reference an MPD attribute located within the MPD at the time of MPD generation may compact and reduce the size of the MPD by utilizing template placement at the Adaptation Set level instead of the Representation level.

Tables 5 and 6 shown below provide XML syntax for encoding and using a generic substitution parameter that references an MPD attribute located within the MPD at the time of MPD generation. Specifically, Table 5 provides the XML syntax that may be used to represent the generic substitution parameter element within an MPD XML file:

```
TABLE 5
<xs:complexType name=“Parameter”>
  <xs:attribute name=“identifier” type=“xs:token” use=“required”/>
  <xs:attribute name=“value” type=“xs:token” use=“required”/>
  <xs:attribute name=“format” type=“xs:token” default=“s”/>
  <xs:attribute name=“location” type=“xs:anyUri”/>
</xs:complexType>
```

As shown in Table 5, the “@location” attribute is expressed using “xs:anyURI.” The type “xs:anyURI” represents a Uniform Resource Identifier (URI) reference that identifies a resource. The type “xs:anyURI” may be absolute or relative. Table 6 provides an example of XML syntax that uses the generic substitution parameter:

```
TABLE 6
<Parameter identifier=“Codec”
    location=“/MPD/Period[1]/AdaptationSet[1]/@codecs”/>
<SegmentTemplate duration=“4” startNumber=“1”
    media=“$RepresentationID$_$Number%05d$.ts?codec=$Codec$” />
```

In Table 6, the generic substitution parameter may be identified as “Codec” and may have a location=“/MPD/Period[1]/AdaptationSet[1]/@codecs,” which may reference a location within the MPD. A substitution parameter at the referenced location may assume a value of any attribute or simple type element (e.g. text-only element). The identifier “Codec” may be referenced within the “@ media” attribute for the “SegmentTemplate” element.

Method 400 may also generate a generic substitution parameter that references a remote element not available during MPD generation at block 402. In other words, the generic substitution parameter reference elements and/or attributes not located within the generated MPD. Referencing a remote element and/or attribute may be beneficial when one or more media segments may be generated by different HTTP servers and/or the MPD is generated in real time, such as in a live broadcast. The substitution of the generic substitution parameters may occur when a streaming client parses the MPD and/or accesses the element. Generating a generic substitution parameter that references a remote element may allow for caching of the MPD during live services. Table 7 provides the semantics of a generic substitution parameter that references a remote element and/or attribute not available during MPD generation:

TABLE 7

| Element or | | |
|---|---|---|
| Attribute | | |
| Name | Use | Description |
| Parameter | | This element contains a generalized description of |
| | | a generic substitution parameter. |
| @identifier | M | Specifies the name for the generic substitution |
| | | parameter |
| @value | M | Specifies a value for the generic substitution |
| | | parameter |
| @format | M | Specifies the format for the generic substitution |
| | | parameter is for a printf-style format string. If not |
| | | present then default to string formatting. |
| @location | O | Specifies an XML Path Language (XPath) |
| | | location path. |
| @maxLength | O | Specifies a maximum length of the value. |
| @encode | O | Specifies encoding request to encode the value. |
| | | Possible options are quoting and base64- |
| | | encoding. The default encoding may be the |
| | | server formatting. |
| @xlink:href | O | Specifies a reference external to the parameter |
| | | element using an XML linking language (Xlink). |
| @xlink:actuate | O | Specifies the processing set, can be either |
| | | “onLoad” or “onRequest.” |

Legend:
For attributes:
M = Mandatory,
O = Optional,
OD = Optional with Default Value,
CM = Conditionally Mandatory.

In Table 7, when a generic substitution parameter is used to reference an MPD element outside the MPD, the parameter element may further comprise an “@location” attribute, an “@maxLength” attribute, an “@encode” attribute, an “xlink:href” attribute, and an “xlink:actuate” attribute. When referencing remote elements, some security considerations may be accounted for using the “@maxLength” attribute and the “@encode” attribute. The “@maxLength” attribute may indicate the maximum length for the “@value” attribute in order to prevent buffer overflows. The “@encode” attribute may specify the encoding used to encode the “@value” attribute. The “@encode” attribute may prevent issues caused by URL-unsafe parameter values and provide an instruction on how to process the value in order to make the parameter values URL safe. The “@encode” attribute may indicate a quoting encode, a base64-encoding, and/or have a default of trusting the server formatting. The “@xlink:href” and “@xlink:actuate” may provide a link to the remote element that provides the “@value” attribute.

Tables 8 and 9 shown below provide XML syntax for encoding and using a generic substitution parameter that references a remote element not available during MPD generation. Specifically, Table 8 provides the XML syntax that may be used to represent the generic substitution parameter element within an MPD XML file:

```
TABLE 8
<xs:complexType name=“Parameter”>
  <xs:attribute name=“identifier” type=“xs:token” use=“required”/>
  <xs:attribute name=“value” type=“xs:token” use=“required”/>
  <xs:attribute name=“format” type=“xs:token” default=“s”/>
  <xs:attribute name=“location” type=“xs:anyUri”/>
  <xs:attribute name=“maxLength” type=“xs:unsignedInt”/>
  <xs:attribute name=“encode” type=“xs:token” default=“none”/>
  <xs:attribute ref=“xlink:href”/>
  <xs:attribute ref=“xlink:actuate” default=“onRequest”/>
</xs:complexType>
```

As shown in Table 8, the “@xlink:href” attribute may be a Xlink function. The generic substitution parameter element may be implemented with a reduced subset of the Xlink function. Table 9 provides an example of XML syntax that uses the generic substitution parameter:

TABLE 9
<Parameter identifier=“AuthToken”
xlink:href=https://drm.example.com/movie/session.cgi?uid=123456789
maxLength=“64”/>
<SegmentTemplate duration=“4” startNumber=“1”
media=“$RepresentationID$_$Number%05d$.ts?sid=$AuthToken$” />

In Table 9, the generic substitution parameter may be identified as “AuthToken” and may have a xlink:href=https://drm.example.com/movie/session.cgi?uid=123456789, which may reference a location outside the MPD and/or the generic substitution parameter element. The identifier “AuthToken” may be referenced within the “@media” attribute for the “SegmentTemplate” element. A request for the URL https://drm.example.com/movie/session.cgi?uid=123456789 may return a complete remote element (e.g. XML parameter) of the generic substitution parameter (e.g. “AuthToken”). In particular, the generic substitution parameter may contain the “@value” attribute. An example of the XLink response may be <Parameter identifier=“AuthToken” value=“123456789”/>.

Generating generic substitution parameters that comprise the “@location” and “@xlink:href” attribute may be used for template construction at the Adaptation Set level. Without the generic substitution parameters, only predefined template variables may be used during template construction at the Adaptation Set level. For example, the Adaptation Set level may be able to refer to a Representation identifier (Id), but may be unable to refer to width and height attributes of different representations in a Segment Template. However, an MPD may refer to the width and height at the Adaptation Set level by using generic substitution parameters that comprise the “@location” and “@xlink:href” attribute. Use of generic substitution parameters in this instance may reduce the size of the MPD. Table 10 provides an example of XML syntax that uses the generic substitution parameter at the Adaptation Set Level:

TABLE 10
<Parameter identifier=“H” location=“/MPD/Period[1]/AdaptationSet[1]/
Representation[@id=$RepresentationId$]/@height”/>

Each time a substitution occurs during the URL construction in a template, the substitution may use the value of the attribute relevant for the representation used to construct the URL. In embodiments where the Xlink uses templates in conjunction with the $Number$ and $Timing$ addressing may produce different values for a generic substitution parameter per each segment. The different values may cause the link to be an invalid HTTP URL and break the URL processing model in DASH. As such, the “@value” attribute for the generic substitution parameter may pertain to a value URL used to fetch a parameter value. Fetching the parameter value as a value string may be more convenient than fetching a complete generic substitution parameter element. Additionally, performing generic substitution parameter substitutions in template constructions for a generic substitution parameter element may cause looping issues. Thus, to avoid looping issues and invalidating the MPD, generic substitution parameter elements may limit substitutions to pre-defined substitution parameters within DASH (e.g. $Number$) instead of other generic substitution parameter elements.

Method 400 may also generate a generic substitution parameter that references a client executed application at block 402. The generic substitution parameter may provide a variable to the streaming client that may perform a computation based on the variable. In other words, a streaming client may perform an operation on the generic substitution parameters and use the result as another parameter. For example, a streaming client may receive the generic substitution parameter and may execute an application that constructs a user identification string. The streaming client may then assign the user identification string to a substitution parameter used for URL construction (e.g. creating URL hash tag/fragment identifier). Table 11 provides an example of XML syntax that uses the generic substitution parameter at the Adaptation Set Level:

TABLE 11
<Parameter identifier=“AvailNumber” format=“d” descriptorId=“42”/>
<Parameter identifier=“AvailsExpected” format=“d” descriptorId=“42”/>

Support for a specific generic substitution parameter (e.g. “AvailNumber”) may be tied to a descriptor (e.g. a generic descriptor and/or a specific descriptor). The descriptor may signal and possibly require support for a given application. As shown in Table 11, the generic substitution parameter element may refer to the descriptor using the “@descriptorId” attribute. Specifically, the “@descriptorId” may reference the “@id” attribute of the descriptor that provides information on how to set the parameter. Certain embodiments of the descriptors are described in more detail in ISO/IEC 23009-1.

Generating generic substitution parameters that references a client executed application may be used to create a cached MPD that may be disturbed amongst one or more clients. Using FIG. 1 as an example, the HTTP server 120 may be configured to generate URL signatures as described in the document, Cisco Internet Streamer CDS 2.0-2.2 API Guide, Annex B, “URL Signing and Validation,” which is incorporated herein by reference. In one embodiment, the HTTP server 120 may be configured to hard code the URL signatures into the MPD. The HTTP server 120 may be aware of the specific clients that are connected to it via a subscriber management system. The HTTP server 120 may then access the parameters and generate the parameter-carrying URL and a digital signature of the URLs for both the media segments and MPD updates. Afterwards, the HTTP server 102 may hard code (e.g. write) the digital signatures and parameters within the MPD.

There are several limitations in hard coding digital signatures and parameters. For example, hard coding may be used for parameters that do not change throughout a period within an MPD. In other words, hard coding may be incompatible with templates that comprise substitution parameters. Whenever a substitution parameter is located within a template, more than one signature value may be possible for the single template attribute. Additionally, hard coding may affect scalability by preventing the MPD from being cached and may need to be generated in real-time because MPD generation is typically user-specific. As such, bottlenecks and performance degradation may occur because of the volume of live users requesting an MPD and/or updated MPD and the need to consult the subscriber management system for each MPD request and/or updated MPD.

The ISO/IEC document 23009-4 entitled “Information technology-Dynamic adaptive streaming over HTTP (DASH)—Part 4: Segment encryption and authentication” (ISO/IEC 23009-4), which is incorporated herein by reference, provides a framework for authentication. A URL signing framework may be implemented by combining the framework in ISO/IEC 23009-4 and using generic substitution parameters that references a client executed application. When a streaming client receives and parses the MPD, the generic substitution parameter may reference a client application (e.g. the @id attribute of a ContentProtection descriptor) used to determine that a key and/or other authentication parameters may be needed to compute a URL signature. Specifically, the streaming client may obtain the key and/or authentication parameters using the framework described in ISO/IEC 23009-4 (e.g. Crypto Period element and/or Content Signature element). One or more generic substitution parameters that reference a remote element may be used for storing the user token and may be used during URL construction of the SegmentTemplate. A URL signature may sign the complete URL (e.g. after URL construction) that comprises the user-specific time-sensitive user token.

FIG. 5 is a flowchart of an embodiment of a method 500 that processes an MPD that comprises one or more generic substitution parameters. Method 500 may be implemented by one or more streaming clients, end user, network element, and/or any other type of device that processes streaming media content. Method 500 may start at block 502 and receive an MPD that comprises one or more generic substitution parameters. Recall that the generic substitution parameters may reference an MPD attribute located within the MPD, a remote element not available during MPD generation, and/or an application performed by a streaming client. The semantics and uses for the generic substitution parameters were discussed above in Tables 4-11.

Method 500 may then move to block 504 and parses through the MPD on demand to locate the generic substitution parameters. In other words, method 500 may move to block 504 and start the substitution process when method 500 needs a parameter value for one or more generic substitution parameters. For example, method 500 may move to block 504 to obtain a parameter value for a generic substitution parameter when constructing a URL for a media segment. Method 500 may not obtain a parameter value for a generic substitution parameter right after receiving the MPD unless method 500 needs the parameter value. In one embodiment, method 500 may access the elements within the MPD to obtain the generic substitution parameters.

Afterwards, method 500 may continue to block 506 and determine if at least one of the generic substitution parameters reference an element and/or attribute within the MPD. If method 500 determines that at least one of the generic substitution parameters reference an element and/or attribute within the MPD, then method 500 moves to block 508 and performs a substitution on the value within the generic substitution parameter that corresponds to the referenced MPD attribute. Afterwards, method 500 proceeds to block 510 to encode the generic substitution parameters within the MPD. Returning to block 506, method 500 may continue to block 510 instead of block 508 if none of the generic substitution parameters reference an element and/or attribute within the MPD.

At block 510, method 500 may determine if at least one of the generic substitution parameters reference a remote element. The remote element may not have been available during MPD generation. If method 500 determines that at least one of the generic substitution parameters reference a remote element, then method 500 moves to block 512 to fetch the remote element that corresponds to the generic substitution parameter. In one embodiment, method 500 may fetch a value string instead of the entire element. After fetching the remote element, method 500 may proceed to block 514 and perform a substitution on the value within the generic substitution parameter that corresponds to the remote element. Method 500 may then move to block 516. Returning to block 510, method 500 may proceed directly to block 516 and without processing blocks 512 and 514 if none of the generic substitution parameters reference a remote element.

At block 516, method 500 may determine if at least one of the generic substitution parameter references an application within the streaming client. If method 500 determines that at least one of the generic substitution parameters references an application within the streaming client, then method 500 may move to block 518 and execute the application that corresponds to the generic substitution parameters. Execution of the application may be client specific and may be based on information known to the client. Afterwards, method 500 may proceed to block 520 and perform a substitution on the value within the generic substitution parameter that corresponds to the computed value obtained in block 518. Method 500 may subsequently end. Returning to block 516, method 500 may end without processing blocks 518 and 520 if none of the generic substitution parameters reference an application within the streaming client.

Generic substitution parameters may also be used for constructing a template for MPD updates, performing generic operations, and synchronization of an HTTP server's clock and a streaming client's clock. In one embodiment, generic substitution parameters may be declared for an MPD update URL for MPD updates. As discussed above, the generic substitution parameters may reference an attribute within the updated MPD, a remote element not available within the updated MPD, and/or a client application. In another embodiment, the XPath may be used by generic substitution parameters to implement generic operations involving variables (e.g. calling functions). Moreover, Extensible Stylesheet Language Transformation (XSLT), which may have its own variables, control flow, and function mechanisms that are well-known in the art, may also be used to implement the generic operations.

Clock synchronization may become an issue when the streaming client and HTTP server are not synchronized by the same Coordinated Universal Time (UTC) clock (e.g. using Network Timing Protocol (NTP) clock). For example, the streaming client may be managed by a global positioning system (GPS) clock and an HTTP server may be managed by the NTP clock. In this instance, the HTTP server may need to generate the MPDs in real time, which prevents caching the MPDs. In one embodiment, a cached MPD may comprise a generic substitution parameter that references a remote element at the MPD level. When the MPD is parsed by the streaming client, the remote element may be fetched from the HTTP server to provide a high-precision timestamp. In another embodiment, when the MPD is generated on the fly, the streaming media preparation unit (e.g. MPD generator) may write a precise timestamp into the “@value” attribute into the “@value” attribute within the generic substitution parameter. Table 12 provides an example of a C-like pseudocode used to reference a timestamp:

TABLE 12

nodes = findnodes(node,“.//Parameter[@id=\“StartTime\”]”);
time= atoll(getAttribute(node,“value”));

As shown in Table 12, the substitution mechanism may rely on the existence of named parameters and attributes corresponding to the named parameter. Thus, the parameter may be a generic substitution parameter that may be passed within the MPD.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g. from about 1 to about 10 includes, 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k*(Rᵤ−R₁), wherein k is a variable ranging from 1 percent to 100 percent with a 1 percent increment, i.e., k is 1 percent, 2 percent, 3 percent, 4 percent, 5 percent, . . . , 70 percent, 71 percent, 72 percent, . . . , 95 percent, 96 percent, 97 percent, 98 percent, 99 percent, or 100 percent. Moreover, any numerical range defined by two R numbers as defined in the above is also specifically disclosed. The use of the term about means ±10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A method for preparing media content in a Dynamic Adaptive Streaming over Hypertext Transfer Protocol (DASH), the method comprising:
generating a parameter that comprises an identifier associated with a string value; and
encoding the parameter within a media presentation description (MPD),
wherein the parameter is configured to be set with a parameter value independently of when the MPD is generated, and
wherein the MPD provides presentation information for a media content.

2. The method of claim 1, wherein the parameter references a location of an element.

3. The method of claim 2, wherein the element is located within the MPD.

4. The method of claim 2, wherein the parameter references the location of the element using equality predicates of the element's identifier.

5. The method of claim 1, wherein the parameter specifies an element not available during the generation of the MPD, wherein the method further comprises receiving a fetch request for the parameter and providing the parameter value via a Hypertext Transfer Protocol in response to the fetch request.

6. The method of claim 5, wherein the parameter further comprises a maximum length attribute that specifies a length limit for the string value and an encode attribute that specifies a type of encoding for the string value.

7. The method of claim 5, wherein the parameter further comprises an @xlink:href attribute and an @xlink:actuate attribute, and wherein the @xlink:href attribute and the @xlink:actuate attribute are used to fetch the parameter value.

8. The method of claim 1, wherein the MPD comprises an Adaptation Set level, and wherein the parameter is encoded at the Adaptation Set level.

9. The method of claim 1, further comprising transmitting the MPD to the client, and wherein the parameter references an application implemented by a client.

10. The method of claim 9, wherein the parameter further comprises a descriptor identifier attribute that references an identifier of a descriptor.

11. An apparatus for preparing media content in a Dynamic Adaptive Streaming over Hypertext Transfer Protocol (DASH), comprising:
a memory;
a processor coupled to the memory, wherein the memory includes instructions that when executed by the processor cause the apparatus to perform the following:
generate a parameter that comprises one or more attributes; and
encode the parameter within a media presentation description (MPD),
wherein the one or more attributes specifies the parameter's name, a value for the parameter, and a format for the value,
wherein the parameter supports setting the value after generating the MPD, and
wherein the MPD describes media content information in DASH.

12. The apparatus of claim 11, wherein the parameter further comprises a location attribute that carries an extensible markup language (XML) Path Language (XPath) location path.

13. The apparatus of claim 11, wherein an identifier attribute from the one or more attributes specifies the parameter's name, wherein a value attribute from the one or more attributes specifies a value for the parameter, and wherein a format attribute from the one or more attributes specifies a format for the value attribute.

14. The apparatus of claim 11, wherein the parameter further comprises an extensible markup language (XML) linking language (Xlink) attribute that references a remote element not located within the MPD.

15. The apparatus of claim 11, wherein the parameter further comprises a descriptor identifier that references a descriptor used to set the parameter.

16. A method for adaptive streaming of a media content in a Dynamic Adaptive Streaming over Hypertext Transfer Protocol (DASH), the method comprising:
receiving a media presentation description (MPD) that provides presentation information for the media content;
determining one or more generic parameters within the MPD; and
substituting one or more values for the generic parameters obtained from the MPD,
wherein the generic parameters reference at least one of the following: one or more attributes within the MPD, one or more remote elements not available during MPD generation, and one or more streaming client applications.

17. The method of claim 16, further comprising fetching the remote elements when the generic parameters reference the remote elements and obtaining the values from the remote elements.

18. The method of claim 16, wherein the values are obtained from at least one of the attributes within the MPD, and wherein the values are used for Uniform Resource Locator (URL) generation.

19. The method of claim 16, further comprising executing the streaming client applications when the generic parameters reference streaming client applications and determining one or more resulting values computed by the streaming client applications.

20. The method of claim 19, wherein the values are obtained from the resulting values.
